(19) United States
(12) Patent Application Publication
(10) Pub. No.: US 2009/0052742 A1
(43) Pub. Date: Feb. 26, 2009

(54) IMAGE PROCESSING APPARATUS AND METHOD THEREOF

(75) Inventor: Yasukazu Okamoto, Akashi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/197,440

(22) Filed: Aug. 25, 2008

(30) Foreign Application Priority Data
Aug. 24, 2007 (JP) 2007-218398

(51) Int. Cl. G06K 9/00

(52) U.S. Cl. 382/104

(57) ABSTRACT

An image processing apparatus includes an image input unit, a line segment extractor, an area extractor, a traveled amount estimator, a kerb and gutter model generator and a kerb and gutter detector, in which an image is divided into areas by a line segment extending along the direction of travel, and kinetic models according to a road surface, a kerb and a gutter respectively are applied to pixels in the area for determination.

### CROSS-REFERENCE TO RELATED APPLICATION

This application is based upon and claims the benefit of priority from the prior Japanese Patent Application No. 2007-218398, filed on Aug. 24, 2007; the entire contents of which are incorporated herein by reference.

### BACKGROUND OF THE INVENTION

The present invention relates to an image processing apparatus configured to detect a traveling environment, in particular, a kerb or a gutter with a camera mounted on a vehicle and method thereof in order to achieve safety drive assistance or automatic traveling of the automotive vehicle.

In the related art, an obstacle detecting system configured to detect obstacles on a road surface, such as 3D objects existing on roads, by mounting a plurality of image pickup devices on a vehicle and comparing a plurality of images by a method of stereo view is proposed.

In the related art described above, since a gutter on the side of the road is located at a level lower than the road surface, it is not determined as the 3D object existing on the road, and hence is not detected as an obstacle.

The kerb of the general road is a step between a sidewalk and a road and has a height of about 15 cm. However, since the height is much lower in comparison with vehicles or pedestrians as objects to be detected in these obstacle detecting methods, detecting only the stereo view is very difficult.

Therefore, in JP-A-2006-18688 (Kokai), a method of identifying a segment which indicates the kerb by extracting a segment from an image and learning characteristic information such as the position or the inclination of the segment or the difference in brightness between the left and right sides of the segment is disclosed.

However, in the method disclosed in JP-A-2006-18688 (Kokai), in the case of the segment based on the characteristics on the road surface such as a white line or a joint line of a pavement and the segment based on the kerb, there is a problem such that the difference in angle between the segment on the road surface such as the white line or the joint line of the pavement and the segment at the upper portion of the kerb is minute, and the difference in angle cannot be identified considering the influence of climate, darkness in the night, and inclination or curve of the road.

Therefore, when the angle of visibility of the image pickup device is reduced to a large extent, the resolution of the image relatively increases, and hence a minute difference in angle may be detected. However, when the angle of visibility is reduced, only the kerb at a long distance from the camera can be included in the field of view, and the difference in angle with respect to other segments is also decreased. When the angle of visibility is small, there arises a problem such that the camera mounted on the vehicle cannot be used for other purposes such as the detection of people or vehicles jumping in front of the vehicle in addition to the detection of the kerb or the white line.

As described thus far, the system using the stereo vision or the segment characteristics in the related art has a problem such that the area including the kerb or the gutter cannot be determined from images.

### SUMMARY OF THE INVENTION

In view of such problems described above, it is an object of the present invention to provide an image processing apparatus which enables determination of areas which include kerbs or gutters of roads from images and a method thereof.

According to embodiments of the invention, there is provided an image processing apparatus that includes a line segment extractor configured to extract a plurality of line segments extending on a road surface along the direction of travel from respective time series images of a road surface in front of a vehicle an area extractor configured to divide the each image into a plurality of divided areas surrounded by the plurality of line segments and two horizontal lines arbitrarily set in the image, a traveled amount estimator configured to obtain the traveled amount of the vehicle, a kerb and gutter model generator configured to (1) detect the road surface area of the road surface surrounded by the two line segments from among the plurality of line segments and the two horizontal lines, (2) generate, assuming that the divided areas located on the lateral side of the road surface area is a kerb area including a portion rising from the road surface, a kerb model area which is obtained from the divided area in the image at a first reference time by deforming and moving in accordance with the movement of the vehicle after an arbitrary time elapsed from the first reference time based on the traveled amount, and (3) generate, assuming that the divided area located on the lateral side of the road surface area is a gutter area including a gutter formed on the road surface, a gutter model area obtained from the divided area in the image at the first reference time by deforming and moving in accordance with the movement of the vehicle after an arbitrary time elapsed from the first reference time based on the traveled amount, and a kerb and gutter detector configured to (1) obtain a first similarity by obtaining a deformed and divided kerb area by deforming and moving the divided area in the image at a second reference time based on the kerb model area relating to the divided area located on the lateral side of the road surface area and matching the deformed and divided kerb area and the divided area in the image after an arbitrary time elapsed from the second reference time, (2) obtain a second similarity by obtaining a deformed and divided gutter area by deforming and moving the divided area in the image at the second reference time based on the gutter model area relating to the divided area located on the lateral side of the road surface area and collating the deformed and divided gutter area and the divided area in the image after an arbitrary time elapsed from the second reference time, and (3) determine that the divided area at the second reference time includes a raised portion or a gutter based on the model area having one of the first similarity and the second similarity which is higher similarity.

According to the invention, kerbs and gutters on both sides of the road surface from the captured time series images are determined.

### BRIEF DESCRIPTION OF THE DRAWINGS

FIG. 1 is a block diagram of an image processing apparatus according to an embodiment of the invention;

FIG. 2 is a drawing of an extracted area;

FIG. 3 is an explanatory drawing illustrating deformation of a road surface;

FIG. 4 is an explanatory drawing illustrating deformation of a kerb; and

FIG. 5 is an explanatory drawing illustrating deformation of a gutter.

### DETAILED DESCRIPTION OF THE PREFERRED EMBODIMENT

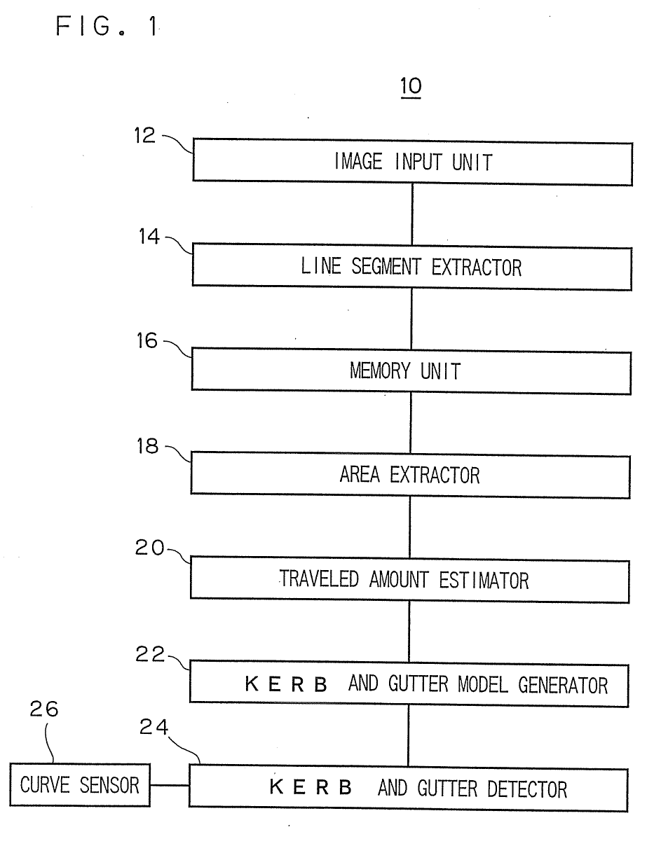

Referring now to FIG. 1 to FIG. 4, an image processing apparatus 10 according to an embodiment of the invention will be described.

The image processing apparatus 10 in the embodiment is configured to detect a kerb or a gutter on the road by being mounted on a vehicle which travels on the road and capturing an image in front of the vehicle.

Referring now to FIG. 1, a configuration of the image processing apparatus 10 according to the embodiment will be described.

As shown in FIG. 1, the image processing apparatus 10 includes an image input unit 12, a line segment extractor 14, a memory unit 16, an area extractor 18, a traveled amount estimator 20, a kerb and gutter model generator 22, a kerb and gutter detector 24 and a curve sensor 26.

The respective components 14 to 26 except for the image input unit 12 may be realized by a program stored in a computer.

Hereinafter, an operation of the respective components 12 to 26 of the image processing apparatus 10 will be described.

The image input unit 12 is a video camera mounted on a vehicle and being capable of capturing kerbs or gutters in front of a vehicle body, and images are entered in time series. At least two of such cameras are necessary when detecting obstacles in a stereo calibration system, and the respective cameras capture a common range.

A camera mounted on the inside of a front window substantially horizontally and directed substantially toward the front is also applicable. Alternatively, cameras mounted near a front bumper of the vehicle so as to be directed obliquely toward the left and right are also applicable.

The line segment extractor 14 extracts a line segment extending from the entered image along the direction of travel of the road.

Extraction of the line segment may be realized by a method of extracting a line segment described in a white line detecting system disclosed in JP-A-2004-334819 (Kokai).

It is also possible to extract a line segment by applying an edge extraction filter such as a Sobel filter or Canny Algorithm to the image and following pixels having an edge strength higher than a threshold value and being adjacent to each other. In this case, the line segment extending along the direction of travel of the vehicle (in the image, a point of infinity in the direction of travel of the vehicle) is extracted.

The memory unit 16 is a storage device configured to store images captured by the image input unit 12 in association with positions of the segments extracted from the images, times at which the images are captured by the image input unit 12, or frame ID numbers allocated to captured images in ascending order.

The area extractor 18 divides the image captured by the image input unit 12 into areas surrounded by two adjacent line segments and arbitrarily set two horizontal lines from among the plurality of line segments extracted by the line segment extractor 14.

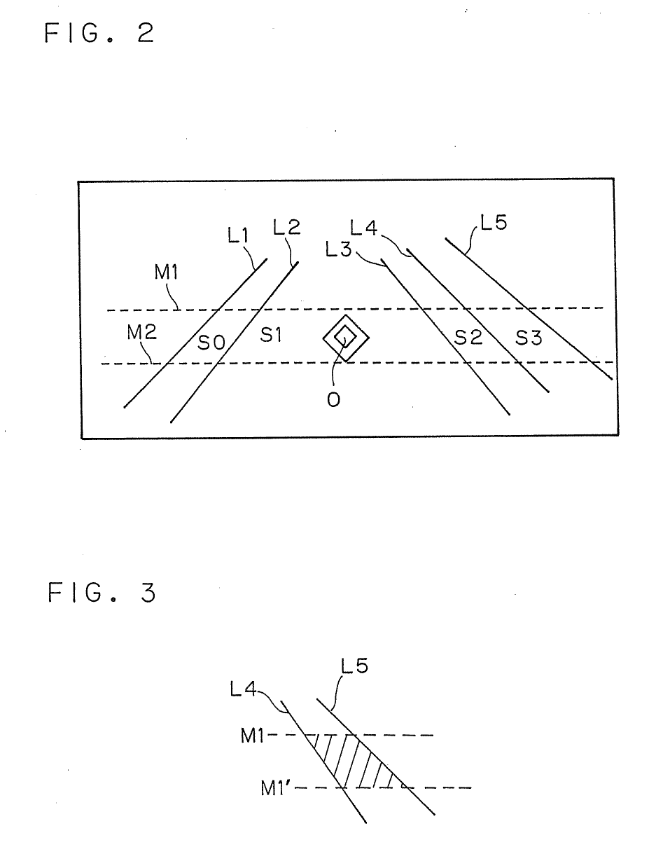

FIG. 2 is an example of an area extracted by the area extractor 18. Solid lines L1 to L5 are line segments extracted by the line segment extractor 14, and broken lines M1 and M2 are arbitrarily set two horizontal lines. Areas S0 to S3 surrounded respectively by the extracted line segments L1 to L4 and the horizontal lines M1 and M2 are extracted areas.

The vertical positions of the horizontal lines M1 and M2 may be determined arbitrarily, or may be determined in reference to a characteristic whose position on the road is easily recognized, such as a paint on the road surface.

The traveled amount estimator 20 obtains kinetic parameters of the vehicle by selecting a road area which shows the road from the areas extracted by the area extractor 18 and collating two images captured at different times.

For the images taken by a camera directed exactly toward the front, an area (S1 in FIG. 2) including the center 0 of the image (a position with a double-square in FIG. 2) is selected as the road area.

In the case of other cameras mounted on a position near the bumper and directed obliquely, the road area is selected by defining a reference such as being in contact with the lower end of the image, or being a largest surface area, which is suitable for the position or direction to mount the camera.

Then, one of the two images to be used which is captured at the time t is designated as an image It, and the other image is designated as an image Idt which is captured at the time elapsed by dt from the time t.

A yt coordinate where a certain point on the road surface at a forward distance Zt from the camera at the time t is expressed by:

$${y}_{t} = \frac{{fY}_{0}}{{Z}_{t}} \qquad ( 1 )$$

where the lateral direction is X-axis, the vertical direction is Y-axis, the depth direction is Z-axis, f is a focal distance, Y0 is the height from the road surface of a camera mounted horizontally and directed exactly toward the front.

The X-axis direction, which corresponds to the horizontal direction, is assumed not to be changed.

The Y-coordinate yt at the time t on the camera image is expressed by:

$${y}_{dt} = \frac{{fY}_{0}}{{Z}_{t} - {Z}_{dt}} \qquad ( 2 )$$

where Zdt is the traveled amount of the vehicle during the time period dt. Since the focal distance f of the camera and the height Y0 of the camera are known, the forward distance Zt from the y-coordinate is obtained.

As regards Zdt, assuming that Zdt has a certain amount, the pixel in the image Idt that the pixel within the road surface area of the image It corresponds to may be calculated according to the expression (1) and the expression (2). Since the image area in Idt corresponding to the road surface area of the image It may be obtained for a certain value of Zdt, the normalized correlation of the image is calculated between the corresponding image areas.

By calculating the normalized correlation by obtaining the image area in Idt corresponding to the road surface area of the image It for respective values of Zdt obtained by shifting by a certain regular amount and selecting Zdt having a highest correlation value, the value Zdt which represents the traveled amount of the vehicle is obtained.

As described above, the traveled amount estimator 20 is able to obtain the kinetic data Zt, Zdt of the vehicle with the calculation described above.

The kerb and gutter model generator 22 calculates the amount of change of the coordinate in the area caused by the movement of the vehicle estimated by the traveled amount estimator 20 when the area extracted by the area extractor 18 is the road surface, the kerb or the gutter.

Referring now to FIG. 3 to FIG. 5, description will be given below.

As shown in FIG. 3, when the area is the road surface, the coordinates on the horizontal line having the same Y-coordinate have the same distance Z with respect to the direction of travel as Z-axis, and hence they move along the horizontal line along with the movement of the vehicle.

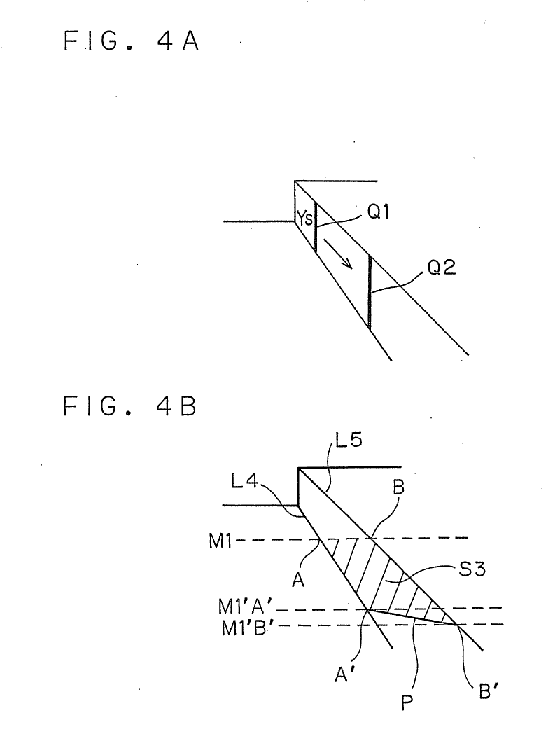

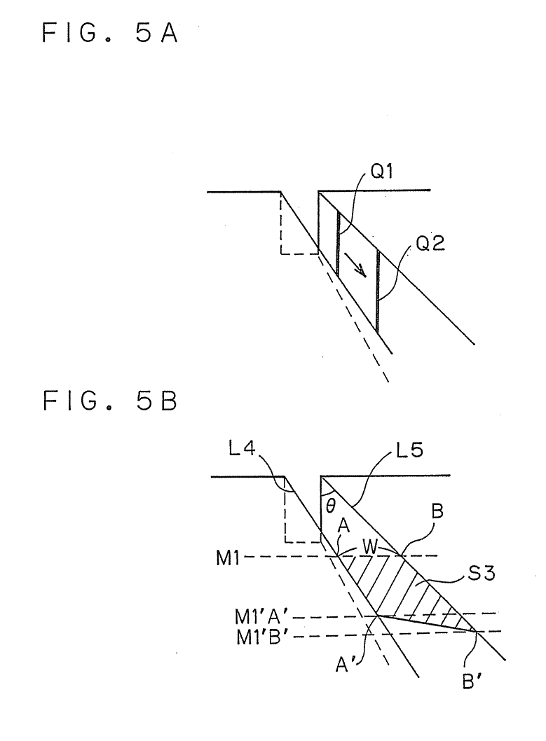

Since the kerb is raised substantially vertically from the road surface by a height Ys as shown in FIG. 4A, the distances Z on the Z-axis of a vertical line Q1 within the area S2 at the time t and of a vertical line Q2 when the time period dt has elapsed after the time t are the same on the kerb existing on the right side of the vehicle.

As shown in FIG. 4B, in the case of the kerb existing on the right side of the vehicle, a pixel A at the left end within the area S2 on the horizontal line M1 is located on the road surface at the time t, and a pixel B at the right end of the horizontal line M1 is located at a level higher than the road surface by the height Ys of the kerb. However, in terms of the distance on the Z-axis, the right pixel B is located at a position closer to the vehicle than the left pixel A.

Therefore, when the vehicle travels toward the front and the time period dt has elapsed after the time t, the traveled distance of B′ on the right side of the area is larger than the traveled distance of A′ on the left side of the area, so that the horizontal line M1 is changed into a line P which is lowered toward the right after the time period dt.

Therefore, the position y′dt of the pixel B′ of the horizontal line M1, which is the destination of the pixel B on the right side reached when the time period dt has elapsed is obtained from the following expression (3). The standard of the height of the kerb is specified by the law, and hence the value of the Ys may be a rated value in the case of the general roads.

$${y}_{dt}^{′} = \frac{f ( {Y}_{0} - {Y}_{s} )}{{Z}_{t} - {Z}_{dt}} \qquad ( 3 )$$

It is assumed that there is no change in the X-axis direction, which is the horizontal direction.

Although the description shown above is the description on the kerb model area of the kerb on the right side of the vehicle, the same description may be applied to the left kerb only by inverting the left and right.

The gutter is fallen substantially vertically as shown in FIG. 5A, the distances Z on the Z-axis of a vertical line Q1 within the area at the time t and of a vertical line Q2 when the time period dt has elapsed after the time t are the same on the right side wall of the gutter existing on the right side of the vehicle (that is, the outer wall).

As shown in FIG. 5B, the pixel B at the right end in the area S2 on the horizontal line M1 is at the same level as the road surface at the time t, and the pixel A at the left end in the area S2 on the horizontal line M1 is at a level lower than the road surface. The reason why it is located at a level lower than the road surface is because the pixel A exists on the right wall of the gutter. Therefore, on the horizontal line M1, the pixel A on the left side of the area S2 is located at a position further from the vehicle than the pixel B on the right side on the Z-axis.

When the vehicle travels toward the front and the time period dt has elapsed after the time t, the pixel B′ at the right end of the area S2 is moved to the same position as the road surface S1 on the left side out of the area S2, and the pixel A′ on the left side of the area S2 is at a far position as described above. Therefore, the area within the area S2 is deformed so as to be higher on the left side, so that disconnections occur inside and outside the area S2 at the left end of the area S2.

As regards the deformation of the area of the gutter, the position y′dt of the pixel A′ at the left end of the area is expressed by:

$${y}_{dt}^{′} = \frac{y - W tan θ}{1 - {Z}_{t} ( \frac{y - W tan θ}{{fY}_{0}} )} \qquad ( 4 )$$

where θ is the inclination of an outline on the right side of the area, w is the width of the area in the horizontal direction.

Although the description shown above is the description on the gutter shoulder model area of the gutter on the right side of the vehicle, the same description may be applied to the gutter on the left side only by inverting the left and right.

The kerb and gutter detector 24 determines the kerb and the gutter by comparing the model of the area generated by the kerb and gutter model generator 22, the area of the image It as an object of detection of the kerb or the gutter and the image of the area of the image Idt.

The temporal relation among the model of the area generated by the kerb and gutter model generator 22, the area of the image It as the object of detection of the kerb and the gutter and the image Itd will be described. It is preferable to extract the image It at the reference time t where the model is generated and extract the image Idt at the time dt where the model is generated. In other words, it is preferable to generate the models using the image of the same frame and detect the kerb or the like using the corresponding image. However, when the computing speed is low, and hence calculation cannot be completed within the same frame, it is also possible to generate a model at a time which becomes a reference of a state where the road surface does not change and detect the kerb or the like on the condition that the road surface does not change much.

A method of detecting the kerb on the right side will be described below. From the road surface area S1 which is already determined as the road surface toward the areas S2, S3 which are adjacently located on the right side are processed in this order.

For the partial area S2, collation of the in-area pixels and the kerb model is performed between the image It and the image Idt. The area S2 is an area surrounded by the two line segments extending along the direction of travel. In this area, two horizontal lines are placed, and a partial area surrounded by the vertical line segments and the two horizontal lines is selected.

The horizontal lines may be selected by selecting a predetermined certain coordinates so that the surface area of the partial area has at least a certain standard area, or may be selected using the characteristics in the image such as a mark on the road surface included in the image of the surface area S1 or the disconnection of the white line which corresponds to the boundary between the areas S1 and S2 as the reference of the Y-coordinate of the horizontal line.

When selecting the Y-coordinate from the characteristics in the image, the standard of selection is the fact that the partial area S2 surrounded by the two horizontal lines is larger than a certain value in surface area, and is located on the lower part of the screen.

The value of Zdt estimated by the traveled amount estimator 20, the expression (2), the expression (3) and the expression (4) as the models of the road surface, the kerb and the gutter are applied to the partial area S2 in the image It selected in the method described above. These models are models to be used for estimating the destination coordinates of a given pixel in the partial area S2 in the image Idt, and the pixel in the image Idt corresponding to the partial area in the image It is identified.

The partial area S2 in the image It and the image area including the corresponding pixels estimated in the respective models in the image Idt are compared, for example, by the inter-image normalized correlation process, and the deformed model having the maximum correlation values, that is, the most similar deformed model is selected.

When the selected deformed model is the road surface, the adjacent areas on the right side are inspected in sequence (the next area S3 is inspected in FIG. 2), and the process is continued until it is detected as the kerb or the road surface, or it reaches the right end of the image.

The same search is performed for the left side of the image leftward from the road surface area.

The curve sensor 26, being a sensor configured with an angular speed sensor such as the steering angle sensor or a yaw rate sensor, detects the fact that the vehicle during travel is significantly curved, and when being curved, emits a signal to stop the process of the kerb and gutter detector 24 described above.

As described above, with the image processing apparatus 10 in this embodiment, the kerbs and the gutters on the right side and the left side of the road surface may be detected only by capturing the images of the front while traveling.

The invention is not limited to the embodiments shown above, and may be modified in various manners without departing the scope of the invention.

While the kerbs of the road are detected in the embodiments shown above, any portions other than the kerbs are detected as long as they rise from the road surface on the sides of the traveling surface. For example, divided highways or the like are exemplified.

While the traveled amount of the vehicle is obtained from the image in the embodiments shown above, the traveled amount may be obtained using a sensor mounted on the vehicle instead.

What is claimed is:

1. An image processing apparatus comprising:
a line segment extractor configured to extract a plurality of line segments extending on a road surface along a direction of travel from respective time series images of a road surface in front of a vehicle;
an area extractor configured to divide the each image into a plurality of divided areas surrounded by the plurality of line segments and two horizontal lines arbitrarily set in the image;
a traveled amount estimator configured to obtain the traveled amount of the vehicle;
a kerb and gutter model generator configured to (1) detect the road surface area of the road surface surrounded by the two line segments from among the plurality of line segments and the two horizontal lines, (2) generate, assuming that the divided areas located on the lateral side of the road surface area is a kerb area including a portion rising from the road surface, a kerb model area which is obtained from the divided area in the image at a first reference time by deforming and moving in accordance with the movement of the vehicle after an arbitrary time elapsed from the first reference time based on the traveled amount and (3) generate, assuming that the divided area located on the lateral side of the road surface area is a gutter area including a gutter formed on the road surface, a gutter model area obtained from the divided area in the image at the first reference time by deforming and moving in accordance with the movement of the vehicle after an arbitrary time elapsed from the first reference time based on the traveled amount; and
a kerb and gutter detector configured to (1) obtain a first similarity by obtaining a deformed and divided kerb area by deforming and moving the divided area in the image at a second reference time based on the kerb model area relating to the divided area located on the lateral side of the road surface area, and collating the deformed and divided kerb area and the divided area in the image after an arbitrary time elapsed from the second reference time, (2) obtain a second similarity by obtaining a deformed and divided gutter area by deforming and moving the divided area in the image at the second reference time based on the gutter model area relating to the divided area located on the lateral side of the road surface area and collating the deformed and divided gutter area and the divided area in the image after an arbitrary time elapsed from the second reference time, and (3) determine that the divided area at the second reference time includes a raised portion or a gutter based on the model area having one of the first similarity and the second similarity which is higher similarity.

2. The apparatus according to claim 1, wherein the kerb and gutter model generator:
stores the height of the rising portion in advance;
sets positions of four intersections between two segments indicating the lower end and the upper end of the rising portion and two horizontal lines respectively at the first reference time;
calculates the positions of the four intersections after having elapsed the arbitrary time from the positions of the four intersections at the first reference time, the height and the traveled amount respectively; and
sets an area surrounded by the four intersections after having elapsed the arbitrary time as the kerb model area.

3. The apparatus according to claim 1, wherein the kerb and gutter model generator:
stores the width of the gutter in advance;
sets the positions of four intersections between two line segments indicating one end and the other end of the gutter and the two horizontal lines at the first reference time respectively;
calculates the positions of the four intersections after having elapsed the arbitrary time from the positions of the four intersections at the first reference time, the width, and the traveled amount respectively; and
sets an area surrounded by the four intersections after having elapsed the arbitrary time as the gutter model area.

4. The apparatus according to claim 1, wherein the second reference time is the same time as the first time or a time before the first time.

5. An image processing method comprising:
extracting a plurality of line segments extending on a road surface along a direction of travel from respective time series images of a road surface in front of a vehicle;
dividing the each image into a plurality of divided areas surrounded by the plurality of line segments and two horizontal lines arbitrarily set in the image;
obtaining the traveled amount of the vehicle;
generating a kerb model and a gutter model by (1) detecting the road surface area of the road surface surrounded by the two line segments from among the plurality of line segments and the two horizontal lines, (2) generating, assuming that the divided areas located on the lateral side of the road surface area is a kerb area including a portion rising from the road surface, a kerb model area which is obtained from the divided area in the image at a first reference time by deforming and moving in accordance with the movement of the vehicle after an arbitrary time elapsed from the first reference time based on the traveled amount, and (3) generating, assuming that the divided area located on the lateral side of the road surface area is a gutter area including a gutter formed on the road surface, a gutter model area obtained from the divided area in the image at the first reference time by deforming and moving in accordance with the movement of the vehicle after an arbitrary time elapsed from the first reference time based on the traveled amount; and
detecting a kerb and a gutter by (1) obtaining a first similarity by obtaining a deformed and divided kerb area by deforming and moving the divided area in the image at a second reference time based on the kerb model area relating to the divided area located on the lateral side of the road surface area, and collating the deformed and divided kerb area and the divided area in the image after an arbitrary time elapsed from the second reference time, (2) obtaining a second similarity by obtaining a deformed and divided gutter area by deforming and moving the divided area in the image at the second reference time based on the gutter model area relating to the divided area located on the lateral side of the road surface area and (2) collating the deformed and divided gutter area and the divided area in the image after an arbitrary time elapsed from the second reference time, and (3) determining that the divided area at the second reference time includes a raised portion or a gutter based on the model area having one of the first similarity and the second similarity which is higher similarity.
